(19) United States
(12) Patent Application Publication
(10) Pub. No.: US 2013/0107672 A1
(43) Pub. Date: May 2, 2013

(54) SEISMIC TRANSDUCING DEVICE

(71) Applicant: Zvi Zlotnick, Haifa (IL)

(72) Inventor: Zvi Zlotnick, Haifa (IL)

(21) Appl. No.: 13/697,533

(22) PCT Filed: Apr. 5, 2011
(86) PCT No.: PCT/IB2011/051466

§ 371 Date: Nov. 13, 2012

(30) Foreign Application Priority Data
May 12, 2010 (IL) 205722

(51) Int. Cl. G01V 1/18

(52) U.S. Cl. CPC G01V 1/186
USPC 367/178

(57) ABSTRACT

A seismic transducing device is provided herein. The device includes a container defining a chamber filled with a medium having a controllable seismic impedance; and a seismic transducer disposed in the medium and affixed to the container; wherein at least a portion of the container, being a membrane, is controllable in terms of tension level over the membrane; wherein the seismic transducer is configured, in a transmitter configuration, to convert electrical signals exhibiting a specified pattern, into seismic waves associated with the specified pattern, and wherein the seismic transducer is configured, in a receiver configuration, to convert reflected seismic waves into electrical associated with the reflected seismic waves.

### BACKGROUND

1. Technical Field

The present invention relates generally to seismic transducers, and more particularly, to transducers for transmitting and receiving seismic waves into and from the ground.

2. Discussion of the Related Art

Seismic transducers are known in the art and are used in a variety of applications. Basically, they are used to convert seismic energy into electrical or mechanical energy and vice versa. Examples for such transducers may be speakers, seismometers, geophones and accelerometers. The transducers may be used, in some configurations, in remote sensing and specifically, ground penetrating sensing.

One challenge of seismic transducers that are directed at ground-related applications is to avoid wave reflection and scattering during passage from one medium to another. This is usually the case when the seismic waves travel from a first medium, exhibiting significantly high seismic impedance into second medium exhibiting significantly low seismic impedance.

Another challenge of seismic transducers is its possibility of transmitting or receiving seismic signal by the same sensor and it may be simultaneous.

Another challenge of seismic transducers based on possibility transmit the arbitrary seismic signal on desired duration.

### BRIEF SUMMARY

One aspect of the invention provides a seismic transducing device that includes: a container defining a chamber filled with a medium having a controllable seismic impedance; and a hydrophone transducer disposed in the medium and affixed to the container; wherein at least a portion of the container, being a membrane, is controllable in terms of tension level over the membrane; wherein the seismic transducer is configured, in a transmitter configuration, to convert electrical signals exhibiting a specified pattern, into seismic waves associated with the specified pattern, and wherein the seismic transducer is configured, in a receiver configuration, to convert reflected seismic waves into electrical associated with the reflected seismic waves.

Another aspect of the invention provides a system comprising: a processor; a storage module; a first interface module coupled to a first hydrophone transducing device; a second interface module coupled to a first seismic transducing device, wherein the processor, in cooperation with the storage module, generates a digital representation of a specified pattern, wherein the first interface module converts the digital representation of the specified pattern into an electrical signal in accordance with the specified pattern, wherein the first seismic transducing device, in response to the incoming electrical signal, generates a seismic wave in accordance with the specified pattern, and wherein at least one of the seismic transducing device comprises at least one of: a medium having a controllable seismic impedance, a membrane having a controllable tension level, and a container having a controllable shape enabling to control seismic radiation pattern of the seismic transducing device.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1A-1D are schematic isometric diagrams illustrating seismic transducing devices according to some embodiments of the present invention;

FIG. 2 is a schematic block diagram illustrating a system according to some embodiments of the present invention; and

FIG. 3A is a spectral diagram showing a specified pattern of a signal in the frequency domain illustrating an aspect of some embodiments of the present invention; and

FIG. 3B is a signal diagram in the time domain illustrating an aspect of some embodiments of the present invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

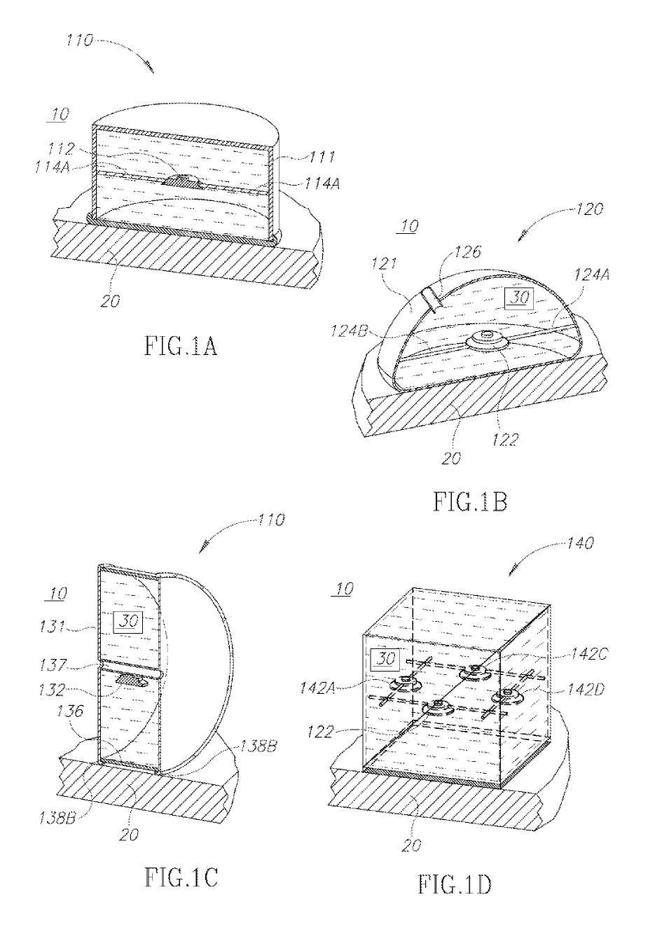

FIGS. 1A-1D are schematic isometric diagrams illustrating seismic transducing devices according to some embodiments of the present invention. The transducing devices basically include each a container filled with a medium having controllable seismic impedance, for example, by means of temperature control of fluid or chemical properties. A primary transducer, such as a hydrophone is disposed within the medium and is affixed to the inner walls of the container. At least portion of the container walls function as a membrane. Properties of the membrane, such as the level are also controllable. Thus, the transducing device may be adjusted in accordance with its ambience for optimizing wave transfer.

FIG. 1A shows an isometric view of a seismic transducing device 110 according to some embodiments of the invention. Seismic transducing device 110 comprises a container 111 defining a chamber filled with medium 30. The medium exhibits controllable seismic impedance. At least a portion of the walls of container 111 define a membrane 115 that exhibits controllable physical properties. A primary transducer 112 may be affixed to the inner walls of container 111 and may be disposed within medium 30 at a specified height above membrane 115. Primary transducer 112 may be electrically coupled to seismic system generator.

In operation, seismic transducing device 110 may be positioned in a first ambience 10 (e.g., air) such that membrane 115, faces second ambience 20 (e.g., ground) wherein the difference between impedance of the respective ambiances is substantially high.

In a first configuration (indicated as transmitter configuration), seismic transducer 112 is configured to receive an electrical signal exhibiting a specified pattern, via the I/O interface, and generate in response to the electrical signal, respective seismic waves directed towards ground 20. Specifically, the electrical signal may exhibit a plurality of specified base frequencies (harmonies) in respective specified amplitudes, over a specified duration of transmission time.

In a second configuration (indicated as receiver configuration), seismic transducer 112 is configured to receive seismic waves reflected by objects located within ground 20 and generate in response, respective electrical signal outputted via I/O interface.

According to some embodiments of the invention, the controllability of the impedance of medium 30 and the physical properties of membrane 115 may be used to adjust the transferability of seismic waves between medium 30 and second ambience 20 and vice versa. Specifically, matching seismic impedance of medium 30 to seismic impedance of second ambience 20 by, for example, increasing the specific gravity of medium 30 may decrease energy losses of seismic waves transfer.

According to some embodiments of the invention, the controllability of the physical properties of membrane 115 may further be used to adjust the transferability of waves between medium 30 and second ambience 20 and vice versa. Specifically by adjusting the tension over membrane 115 the geometric shape of the membrane surface and match the geometric shape of the overlapping portion of second ambiance 20 such that excessive air pockets (first ambience 10) are eliminated to yield an airtight coupling of seismic transducing device 110 to second ambiance 20 (e.g., the ground). In one embodiment, fastening elements 118A-118D are in operative association with the rim of membrane 115 and are configured to control the tension over membrane 115. Other means of controlling the tension and the shape of membrane 115 may be used.

According to some embodiments of the invention, further controllability of the spatial shape, and other physical properties of container 111 may be used to adjust the radiation curve of the seismic waves generated by seismic transducing device 110. Specifically, types of seismic waves as well as modes of operation and configurations may be thus controlled and adjusted in order to meet specific application requirements.

FIG. 1B shows an isometric view of another seismic transducing device 110 according to some embodiments of the invention. Seismic transducing device 120 comprises a container 121 defining a chamber filled with medium 30. Seismic transducer 122 may be affixed to the inner walls of container 121 via support elements 124A and 124B. Also here, medium 30 exhibits controllable seismic impedance. Controlling the seismic impedance of medium 30 may be achieved, for example, by adding a substance having higher (or lower) specific gravity via nozzle 126. Alternatively, particles such as small balls may be added via nozzle 126. The seismic impedance of medium 30 may also be controlled by heating or cooling medium 30. Container 121 may be made of a flexible, seismically transparent material. The flexibility of container 121 may be selected such that membrane 125 may autonomously acquire the shape of the overlapping surface of second ambience 20. Alternatively, further amounts of medium 30 may be inputted via nozzle 126 to control the tension over membrane 125.

FIG. 1C shows an isometric view of yet another seismic transducing device 130 according to some embodiments of the invention. Seismic transducing device 130 comprises a container 131 shaped as a cylinder and rotatable along an axis 137 to for a roller. Container 131 defines a chamber filled with medium 30. Seismic transducer 132 may be rotatable affixed to the inner walls of container 131 in proximal to axis 137 such that when container 131 rotates around axis 137, Seismic transducer 132 remains stationary, in angular terms, in relation to second ambiance 20 (e.g., ground). Also here, medium 30 exhibits controllable seismic impedance. Additionally, tension over membrane 136 may be controlled using fastening elements 138A-138D scattered along the rim of membrane 136.

FIG. 1D shows an isometric view of yet another seismic transducing device 140 according to some embodiments of the invention. Seismic transducing device 140 comprises a container 141 in the shape of a box defining a chamber filled with medium 30 by means of some array of primary transducer. A plurality of seismic transducers 142A-142D may be affixed to the inner walls of container 122 via support elements 144A-144D. Also here, medium 30 exhibits controllable seismic impedance. The use of a plurality of primary transducers in array 142A-142D enable to further control the shape the primary radiation curve of seismic transducing device 140. Specifically, operating each one of seismic transducers 142A-142D at a specified period, a specified magnitude, and in accordance with a specified signal form enables more levels of freedom in shaping the seismic wave radiation curve of seismic transducing device 140.

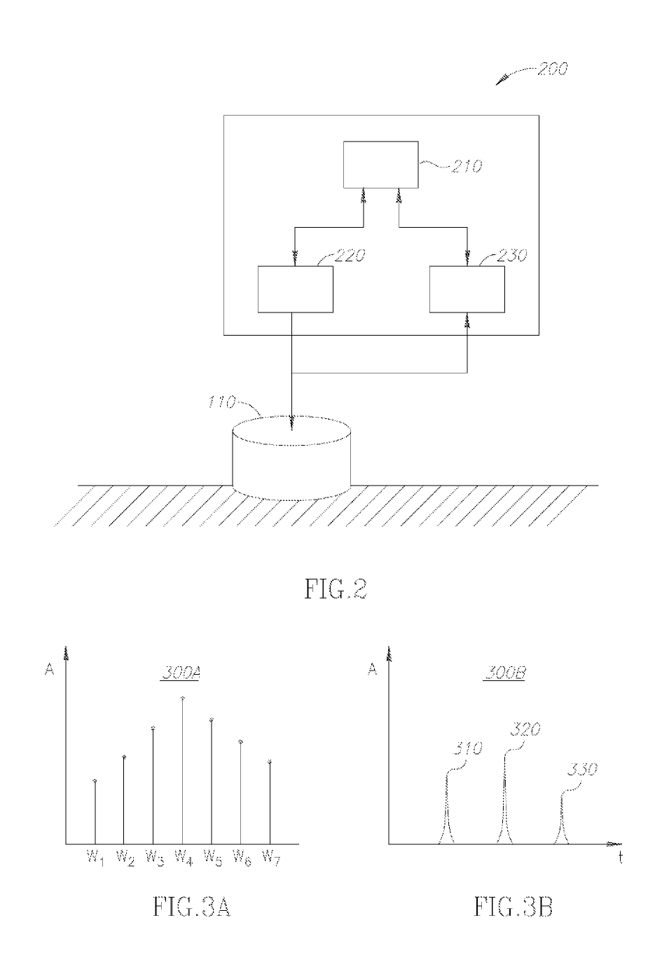

FIG. 2 is a schematic block diagram illustrating a system according to some embodiments of the present invention. System 200 comprises a processing module 210, a transmitting interface module 220, and a receiving interface module 240 receiver amplifier. A seismic transducing device 110 is in communication (either via wire line or wireless) with interface modules 220 and 230.

In operation, processing module 210, generates a digital representation of a specified pattern. This pattern corresponds with the desired pattern of the seismic waves that would be transmitted by seismic transducing device pattern towards the ground, and may be set in accordance with prior knowledge about the properties of the ground and the properties of the object within the ground. Interface transmitting module 220 converts the digital representation of the specified pattern into an electrical signal in accordance with the specified pattern. Then, seismic transducing device 110, in response to the incoming electrical signal, generates a seismic wave in accordance with the specified pattern. Specifically, the electrical signal may exhibit a plurality of specified base frequencies (harmonies) each having respective specified amplitude, over a specified duration of transmission time. FIG. 3A is a spectral diagram showing such a specified pattern 300A of a signal in the frequency domain. Each of the frequencies is assigned with specified amplitude.

In a second configuration (indicated as receiver configuration), seismic transducing device 110 is configured to receive seismic waves reflected by objects located within ground 20 and generate in response, a respective electrical signal outputted via receiving interface module 230. Specifically, the incoming electrical signal is passed through a plurality of filters, each filter associated with a respective base frequency such that for each base frequency, the electrical signal representing the reflected seismic waves is sampled over a specified receiving duration. Thus, data processing module 210 receives a set of temporal samples of the reflected seismic signal, for each base frequency along the spectral range of the transmitted seismic signal.

Data processing module 210 is then used to extract temporal data from the spectral representation of the reflected samples. Data processing module 210 is configured to perform an inverse Fourier transform on the samples of the reflected signals over the entire range of the base frequencies. Thus, the inverse Fourier transform may be applied to the reflected samples over the frequency domain yields a temporal representation of the reflected signal. FIG. 3B is a signal diagram in the time domain illustrating a temporal representation being the inverse Fourier transform of the reflected samples, over the entire frequency range of the transmitted signal. Pulses 310-330 represent reflections from objects within the ground and so they enable to extract distances (depths) and properties (according to the amplitude, for example).

The inventor has discovered that by using a transmitted signal that comprises a large range of seismic frequencies, for example from 10 Hz to 5,000 Hz, the inverse Fourier transform of the reflected samples, executed over the entire range of seismic frequencies, a temporal representation of the reflected signal may be achieved, in which reflections from underground objects may be in the form of pulses (sometimes referred to “synthetic pulses”). This is due to the relatively large range of seismic frequencies used.

According to some embodiments, the reflected seismic waves are sampled over a specified receiving duration time. The samples for each base frequency may be then averaged such that the average sample for each frequency is being used in the inverse Fourier transform. Alternatively, several inverse Fourier transforms may be performed for samples having the same timestamp and averages or selected in accordance with specified criteria.

According to some embodiments, both transmitting duration time and receiving duration time may be selected in accordance with the physical properties of the ground, the properties of the objects within the ground, their depth and the generally the depth of ground that needs to be covered. It is understood that these durations may be controlled during operation in order to achieve optimized results in terms of accuracy and resolution of the temporal representation of the reflected seismic waves.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A seismic transducing device comprising:
a container defining a chamber filled with a medium having controllable physical properties; and
a hydrophone disposed in the medium and affixed to the container,
wherein at least a portion of the container, being a membrane, is controllable in terms of tension level over the membrane,
wherein the seismic transducer is configurable in at least one of: (i) transmitter configuration and (ii) receiver configuration,
wherein in the transmitter configuration, the seismic transducer is arranged to transmit seismic waves having a specified pattern into a second medium coupled to the membrane, and
wherein in the receiver configuration the seismic transducer is arranged to receive seismic waves having a specified pattern reflected from a second medium coupled to the membrane.

2. The seismic transducing device according to claim 1, wherein the container's shape is further controllable to enable shaping of a seismic radiation curve associated with the seismic transducing device.

3. The seismic transducing device according to claim 1, wherein the container is in a shape of a roller rotatable around an axis, and wherein the hydrophone is operatively associated with the axis such that when the roller rotates around the axis, the hydrophone remains angularly stationary.

4. The seismic transducing device according to claim 1, wherein the membrane is adjustable to conform to the shape of the second medium's surface coupled thereto.

5. The seismic transducing device according to claim 1, further comprising a plurality of fastening elements operatively associated with the membrane, enabling adjustment of tension over the membrane, usable for amplitude and phase matching between the device and the second medium coupled to the membrane.

6. The seismic transducing device according to claim 1, wherein the container is made of substantially an inflatable material.

7. The seismic transducing device according to claim 1, wherein the container comprises an inlet for adding substance into the medium usable for controlling the medium's seismic impedance.

8. A system comprising:
a data processing module;
one or more seismic transducer devices; and
an interface module coupled to the seismic transducing device and to the data processing module,
wherein the processing module, in cooperation with the interface module, are configured to generate a plurality of pulses each in a distinct frequency, over a wideband frequency range over a first specified period of time,
wherein each one of the seismic transducer devices is arranged to:
convert the plurality of pulses into corresponding seismic waves
convert reflections of the seismic waves into reflected pulses,
wherein the data processing module is further arranged to sum up the reflected pulses within the wideband frequency range, over a second period of time, thus implementing an inverse transform Fourier resulting in a temporal synthetic pulse representing a location of an object associated with the reflected seismic waves.

9. system according to claim 8, wherein the seismic transducing device comprises a hydrophone disposed within a medium within a container and further comprises a least one of: a medium having a controllable seismic impedance, a membrane having a controllable tension level, and a container having a controllable shape enabling to control seismic radiation pattern of the seismic transducing device.

10. The system according to claim 8, wherein the second specified period of time is selected in accordance with an object detection depth range of the transducer.

11. The system according to claim 8, wherein the seismic transducing devices are configurable is any arbitrary spatial deployment based on user selection.

12. A method comprising:
generating a plurality of pulses each in a distinct frequency, over a wideband frequency range over a first period of time;
converting the plurality of pulses into corresponding seismic waves;
converting reflections of the seismic waves into reflected pulses; and
summing up the reflected pulses within the wideband frequency range, over a second period of time, thus implementing an inverse transform Fourier resulting in a temporal synthetic pulse representing a location of an object associated with the reflected seismic waves.

13. The method according to claim 12, wherein each of the converting is carried out over a seismic transducing device exhibiting controllable physical properties.
